(19) United States
(12) Patent Application Publication
(10) Pub. No.: US 2006/0239391 A1
(43) Pub. Date: Oct. 26, 2006

(54) Evaluating base station timing in an asynchronous network

(76) Inventor: Michael J. Flanagan, Chester, NJ (US)

Correspondence Address: WILLIAMS, MORGAN & AMERSON, 10333 RICHMOND, SUITE 1100, HOUSTON, TX, 77042, US

(21) Appl. No.: 11/110,486

(22) Filed: Apr. 20, 2005

(51) Int. Cl. H04L 7/00

(52) U.S. Cl. 375/354

(57) ABSTRACT

The present invention provides a method of wireless communication with at least one mobile unit and at least two base stations. The method includes determining a phase difference between at least two timing signals associated with said at least two base stations based upon timing information provided by said at least one mobile unit from at least one known location.

### BACKGROUND OF THE INVENTION

1. Field of the Invention

This invention relates generally to communication systems, and, more particularly, to wireless communication systems.

2. Description of the Related Art

Wireless communication systems include one or more base stations (also referred to as node-Bs) that may provide wireless connectivity to one or more mobile units in a geographical area, or cell, associated with the base station. In some wireless communication systems, base station timing is synchronous with a stable reference clock. For example, the timing of base stations that operate according to a Code Division Multiple Access (CDMA 2000) protocol is required to be synchronous with the timing of the Global Positioning System (GPS). Mobile units that are communicating with a CDMA 2000 base station over an air interface effectively are also locked to the GPS timing. The phase of the timing signal used by the base station and the mobile units in a synchronous wireless communication system is constant within very tight constraints.

Synchronous timing requirements have not, however, been adopted by all wireless communication standards. For example, Universal Mobile Telecommunication Service (UMTS) protocols use asynchronous timing. The base stations and/or mobile units in an asynchronous wireless communication system are not required to lock to a stable reference clock, such as may be provided by GPS. Consequently, the base station and/or mobile unit timing is less accurate than in a synchronous wireless communication system and the phase of the timing signal may drift and/or wander over time. For example, the timing signal in the UMTS standard is required to maintain an accuracy of approximately 25 ppm. Thus, a 1 MHz timing signal may fluctuate and/or vary by as much as 25 hertz, which may cause substantial drift and/or wandering of the timing signal over relatively short time periods.

The drift and/or wandering of the timing signal may introduce unknown and/or unpredictable phase differences between the timing signals used by different base stations. Consequently, the accuracy of measurements and/or calculations based on timing signals provided by different base stations may be reduced. For example, it may not be possible to determine positions of mobile units by triangulating with measured round-trip delays of signals provided by different base stations. This problem may be exacerbated by the fact that many asynchronous mobile units do not include a GPS capability, and those asynchronous mobile units that do include a GPS capacity may have this capability disabled by the user.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later. The present invention is directed to addressing the effects of one or more of the problems set forth above.

In one embodiment of the instant invention, method is provided for wireless communication with at least one mobile unit and at least two base stations. The method may include determining a phase difference between at least two timing signals associated with said at least two base stations based upon timing information provided by said at least one mobile unit from at least one known location.

In one embodiment of the present invention, a method is provided for wireless communication using at least two base stations. The method may include providing timing information from a known location in response to receiving at least two signals from said at least two base stations, the timing information being indicative of a phase difference between at least two timing signals associated with the at least two base stations.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 conceptually illustrates a second exemplary embodiment of a wireless communication system, in accordance with the present invention; and

FIG. 3 conceptually illustrates one exemplary embodiment of a method for evaluating base station timing in an asynchronous network, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

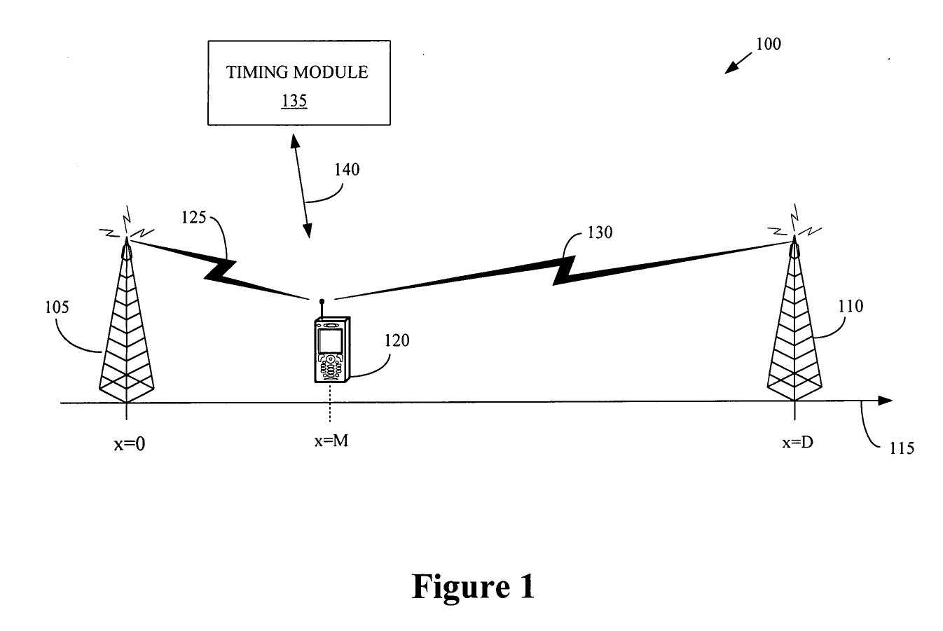

FIG. 1 conceptually illustrates a first exemplary embodiment of a wireless communication system 100. In the first exemplary embodiment, the wireless communication system 100 is a portion of an asynchronous network. For example, a wireless communication system may be a portion of a network that operates according to a Universal Mobile Telecommunication System (UMTS) protocol. However, persons of ordinary skill in the art should appreciate that the present invention is not limited to networks that operate according to the UMTS protocol. In alternative embodiments, the wireless communication system 100 may operate according to any protocol or combination of protocols.

In the illustrated embodiment, the wireless communication system 100 includes two base stations 105, 110 separated by a distance D along the access 115. The base stations 105, 110 may provide wireless connectivity within geographic areas, or cells, associated with the base stations 105, 110. A mobile unit 120 is deployed at a known location proximate the base stations 105, 110. Although a single mobile unit 120 is shown in FIG. 1, persons of ordinary skill in the art should appreciate that any desirable number of mobile units 120 may be deployed proximate the base stations 105, 110. Exemplary mobile units 120 include cellular telephones, personal data assistants, smart phones, text messaging devices, laptop computers, and the like. In one embodiment, the mobile unit 120 is a dedicated device used to evaluate timing of the base stations 105, 110. However, the present invention is not limited to dedicated mobile units 120. In alternative embodiments, any mobile unit 120, including mobile units 120 used by subscribers to the wireless communication system 100, may be used. In the illustrated embodiment, the mobile unit 120 is deployed a distance M from the base station 105 and a distance D-M from the base station 110. Persons of ordinary skill in the art should appreciate that the mobile unit 120 may be deployed at any distance from the base stations 105, 110. Furthermore, the mobile unit 120 may be stationary or in motion.

The mobile unit 120 forms wireless communication links 125, 130 (sometimes referred to as air interfaces) with the base stations 105, 110, respectively. As discussed above, the wireless communication links 125, 130 may be formed according to any protocol or combination of protocols. The base stations 105, 110 provide signals, such as timing signals, which may be received by the mobile unit 120 over the wireless communication links 125, 130. For example, the base stations 105, 110 may transmit one or more pilot signals. In one embodiment, the signal transmitted from the base station 105 can be written as s(t−p₀(t)) and the signal transmitted from the base station 110 can be written as s(t−p_{D}(t)), where the unknown timing delays associated with the base stations 105, 110 are denoted by p₀(t) and p_{D}(t), respectively. The signals received by the mobile unit 120 over the wireless communication links 125, 130 can be written as s(t−p₀(t)−M/c) and s(t−p_{D}(t)−(D−M)/c), respectively (where c is the speed of light).

The mobile unit 120 determines timing information based upon the signals received from the base stations 105, 110. In one embodiment, the mobile unit 120 may determine the timing information (p₀(t)+M/c) and (p_{D}(t)+(D−M)/c) using the signals received from the base stations 105, 110. For example, the mobile unit 120 may estimate relative phases of pilot signals transmitted by the base stations 105, 110. However, the present invention is not limited to the timing information (p₀(t)+M/c) and (p_{D}(t)+(D−M)/c). In alternative embodiments, the mobile unit 120 may determine any desirable type of timing information. For example, the mobile unit 120 may determine a relative phase difference between the signals received from the base stations 105, 110.

The mobile unit 120 provides the timing information associated with the base stations 105, 110 to a timing module 135. In one embodiment, the mobile unit provides the timing information to the timing module 135 using a separate communication link 140, which may include a wired segment, a wireless segment, or any combination thereof. However, the present invention is not limited to using a separate communication link 140. In alternative embodiments, the mobile unit 120 may provide the timing information over one or more of the air interfaces 125, 130. For example, the mobile unit 120 may designate the base station 105 as a primary base station and may provide the timing information to the timing module 135 via the wireless communication link 125 to the primary base station 105. In various alternative embodiments, the timing module may be implemented in hardware, software, or any combination thereof.

The timing module 130 determines the timing of the base stations 105, 110 based on the timing information provided by the mobile unit 120. In the illustrated embodiment, the location of the mobile unit 120 is known to be x=M. Since M, D and c are known, the timing delays, p₀(t) and p_{D}(t), can be determined, thereby determining the timing of the base stations 105, 110. In various alternative embodiments, the timing delays may be determined using line-of-sight and/or non-line-of-sight techniques. For example, the timing information may include the signals received by the mobile unit 120, in which case the received signals associated with the base stations 105, 110 may be correlated to determine the timing delays. For another example, the timing information may include a relative phase difference between signals provided by the base stations 105, 110, which may be combined with information indicative of a round-trip delay between the mobile unit 120 and one (or both) of the base stations 105, 110 to determine the time delays.

The timing information can be sampled at a rate appropriate for the timing delay waveforms under study. In one embodiment, the sampling rate is determined based upon the rate at which the phase difference is changing (sometimes referred to as a slip rate). For example, if the phase difference is changing at approximately a rate of one chip per second and half-chip accuracy is desired then the timing information may be sampled at a rate that is higher than a Nyquist frequency associated with the slip rate.

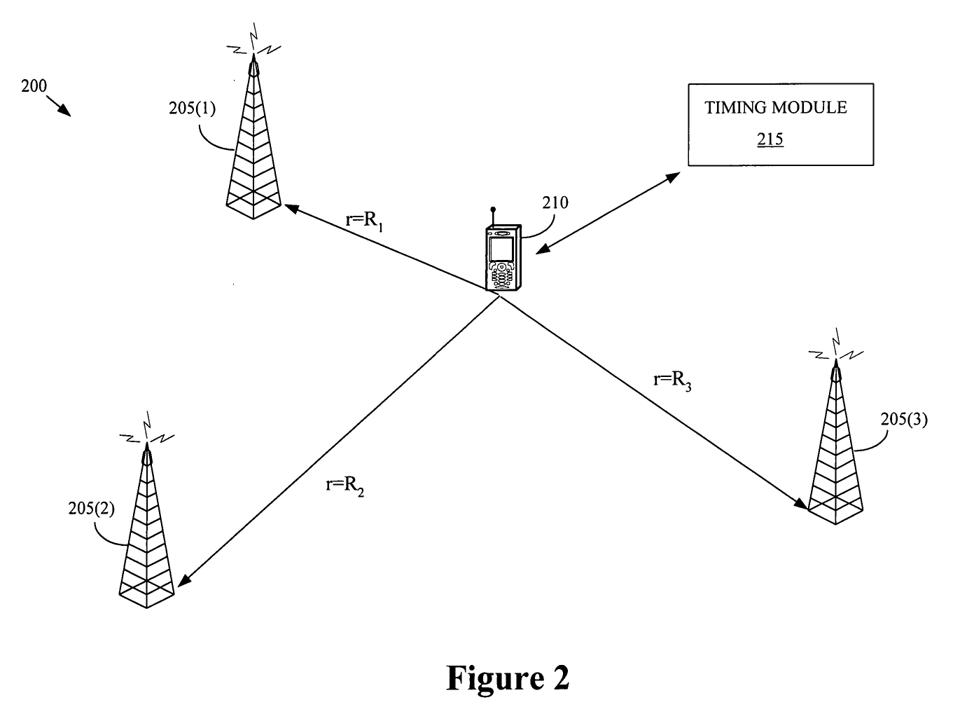

FIG. 2 conceptually illustrates a second exemplary embodiment of a wireless communication system 200. The second exemplary embodiment of the wireless communication system 200 is a portion of an asynchronous network, as discussed above. The wireless communication system 200 includes three base stations 205(1-3) that provide wireless connectivity to associated cells. Although three base stations 205(1-3) are depicted in FIG. 2, persons of ordinary skill in the art should appreciate that any desirable number of base stations 205(1-3) may be deployed. As discussed above, the wireless connectivity may be provided according to any desirable protocol or combination of protocols. One or more mobile units 210 are deployed proximate the base stations 205(1-3) and may form wireless communication links with the base stations 205(1-3).

The base stations 205(1-3) provide signals, such as timing signals, which may be received by the mobile unit 210 over wireless communication links or air interfaces (not shown). In one embodiment, the signal transmitted from the base station 205(1) can be written as s(t−p₁(t)), the signal transmitted from the base station 205(2) can be written as s(t−p₂(t)), and the signal transmitted from the base station 205(3) can be written as s(t−p₃(t)), where the unknown timing delays associated with the base stations 205(1-3) are denoted by p₁₋₃(t), respectively. The corresponding signals received by the mobile unit 210 can be written as s(t−p₁(t)−R₁/c), s(t−p₂(t)−R₂/c) and s(t−p₃(t)−R₃/c), respectively (where c is the speed of light).

The mobile unit 210 provides the timing information associated with the base stations 205(1-3) to a timing module 215. As discussed above, the mobile unit 210 may provide the timing information using a separate communication link, over one or more of the air interfaces with the base stations 205(1-3), or in any other manner. The timing module 215 determines the timing of the base stations 205(1-3) based on the timing information provided by the mobile unit 210. In the illustrated embodiment, the location of the mobile unit 210 is known and the timing delays, p₁₋₃(t) can be determined, thereby determining the timing of the base stations 205(1-3), which may be used to determine one or more phase differences. In various alternative embodiments, the timing delays may be determined using line-of-sight and/or non-line-of-sight techniques. The timing information can be sampled at a rate appropriate for the timing delay waveforms under study.

In one embodiment, a plurality of mobile units 210 may be deployed in the wireless communication system 200. Each of these mobile units 210 may receive signals, such as pilot signals, from the base stations 205(1-3) and use these signals to determine timing information. The timing information may then be provided to the timing module 215, which may determine timing of the base station 205(1-3) using timing information from one or more of the mobile units 210. The signals may be received at the plurality of mobile units 210, and the timing information generated and provided to the timing module 215, simultaneously, concurrently, and/or during non-overlapping time intervals. Moreover, one or more of the mobile units 210 may move before, during, and/or after receiving the signals, determining timing information, and/or providing the timing information to the timing module 215.

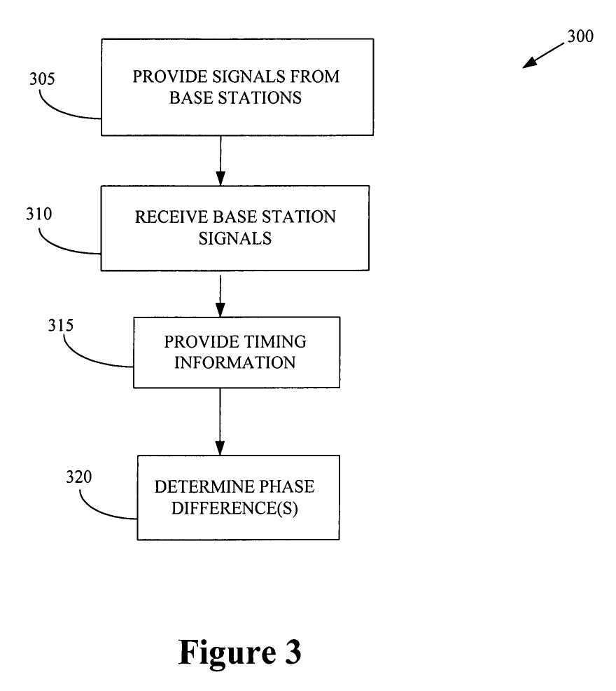

FIG. 3 conceptually illustrates one exemplary embodiment of a method 300 for evaluating base station timing in an asynchronous network. In the illustrated embodiment, signals are provided (at 305) by a plurality of base stations, such as the base stations 105, 110, 205(1-3) shown in FIGS. 1-2. The signals are received (at 310) by one or more mobile units, which may then provide (at 315) timing information based upon the received signals. The timing information may then be used to determine (at 320) at least one phase difference between the timing of the base stations. For example, the timing information may be used to determine (at 320) one or more time delays associated with one or more of the plurality of base stations, which may be used to determine (at 320) a phase difference between at least two of the plurality of base stations.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication with at least one mobile unit and at least two base stations, comprising:
determining a phase difference between at least two timing signals associated with said at least two base stations based upon timing information provided by said at least one mobile unit from at least one location.

2. The method of claim 1, wherein determining the phase difference between said at least two timing signals comprises determining at least two timing delays associated with said at least two timing signals.

3. The method of claim 1, wherein determining the phase difference between said at least two timing signals comprises sampling said timing information at a selected rate.

4. The method of claim 3, wherein sampling said timing information at the selected rate comprises sampling said timing information at a sampling rate selected based upon a timing delay waveform associated with said timing information.

5. The method of claim 4, wherein sampling said timing information at the selected rate comprises sampling said timing information at approximately a Nyquist frequency associated with the timing delay waveform.

6. The method of claim 1, wherein determining the phase difference between said at least two timing signals based upon the timing information comprises determining the phase difference between said at least two timing signals based upon at least two signals received by said at least one mobile unit.

7. The method of claim 6, wherein determining the phase difference comprises correlating said at least two signals received by said at least one mobile unit.

8. The method of claim 1, wherein determining the phase difference comprises determining at least one round-trip-delay associated with at least one of said at least two signals received by said at least one mobile unit.

9. A method of wireless communication using at least two base stations, comprising:
providing timing information from a known location in response to receiving at least two signals from said at least two base stations, the timing information being indicative of a phase difference between at least two timing signals associated with the at least two base stations.

10. The method of claim 9, wherein providing said timing information comprises providing timing information indicative of at least two timing delays associated with said at least two timing signals.

11. The method of claim 9, wherein providing said timing information comprises providing timing information indicative of at least at least one round-trip-delay associated with at least one of said at least two signals received from said at least two base stations.

12. The method of claim 9, wherein providing said timing information comprises providing said timing information to at least one of said at least two base stations.
